(19) United States
(12) Patent Application Publication
(10) Pub. No.: US 2026/0161374 A1
(43) Pub. Date: Jun. 11, 2026

(54) SYSTEM AND METHOD FOR FINETUNING A CODE TRANSLATION MODEL

(71) Applicant: Quantiphi, Inc, Marlborough, MA (US)

(72) Inventors: Dagnachew Birru, Marlborough, MA (US); Shreya Saxena, Mumbai (IN); Siva Prasad Sompalli, Mumbai (IN); Zishan Ahmad, Mumbai (IN); Vishal Vaddina, Toronto (CA)

(73) Assignee: Quantiphi, Inc, Marlborough, MA (US)

(21) Appl. No.: 18/975,109

(22) Filed: Dec. 10, 2024

(51) Int. Cl. G06F 8/51; G06F 11/3668

(52) U.S. Cl. CPC G06F 8/51; G06F 11/3692

(57) ABSTRACT

A system (100) for fine-tuning a code translation model is disclosed. The system comprises a processing arrangement (102) and a user device (104). The processing arrangement is configured to receive at least one seed sample in a source code language, a code translation base model, and a set of system specific requirements, from a user device. The processing arrangement is configured to generate synthetic dataset comprising training dataset and evaluation dataset; determine at least one parameter to finetune the code translation model; finetune the code translation model based on at least one parameter; evaluate the code translation model to generate a evaluation score; determine a training loss and an evaluation loss; based on the evaluation score, the training loss and the evaluation loss, finetune the code translation model or approve the code translation model. A method for fine-tuning a code translation model is also disclosed.

### FIELD OF TECHNOLOGY

The present disclosure generally relates to finetuning models. Specifically, the present disclosure relates to a system and a method for finetuning a code translation model.

### BACKGROUND

Generally, code translation i.e., translating a code written in one code language (for example, C++) to another code language (for example, Java) is required when performing legacy code migration or platform migration. Instead of rewriting code in a new code language translating the code seems efficient and reduced requirement of skilled professionals. In this regard, code translation is generally performed using available closed source large language models (LLMs) hosted through external application platform interfaces (APIs). However, using the closed source LLMs hosted through external APIs for code translation possesses a risk of security breach and data leakage.

As a result, in some existing solutions an open-source code translation model is used for accelerating code translation. However, the performance of the open-source code translation model shows inferior operational efficiency in terms of time taken for translation and quality of translated code, compared to the closed source LLMs hosted through external APIs.

In other existing solutions, an in-house code translation model is used for the code translation. However, training and finetuning the in-house code translation model, require high amount of language specific training data and benchmark datasets specifically designed for evaluating code translation tasks. Moreover, when running the in-house code translation model, an output code is usually generated against input data set implemented as unit test cases and there may be discrepancies between declarations of a function in the unit test cases and the generated output code. Furthermore, due to limited availability of the language specific training data and the benchmark datasets, determining effective finetuning method, appropriate training parameters, and required number of data samples for achieving the best-performing model, becomes challenging affecting performance of the in-house code translation model. Moreover, the high amount of language specific training data and the benchmark datasets that are required by the existing code translation models makes the existing code translation models expensive to implement and requiring high computational resources

Therefore, in light of the foregoing discussion, there exists a need to overcome the aforementioned drawbacks.

### BRIEF SUMMARY OF THE DISCLOSURE

The present disclosure provides a system and a method for finetuning a code translation model. The present disclosure seeks to provide a solution to the existing problem of lack of language specific training data and benchmark datasets to translate a code from one language to another, related to a specific use case scenarios. The aim of the present disclosure is to determine the most effective method for finetuning the code translation model based on a suitable training method and initial parameters selected by a user. The aim of the present disclosure is to provide a solution that overcomes at least partially the problems encountered in the prior art.

In one aspect, the present disclosure provides a system for finetuning a code translation model. The system comprises a processing arrangement. The processing arrangement is configured to receive at least one seed sample in a source code language, the code translation model, and a set of system specific requirements, from a user device, wherein the set of system specific requirements comprises: a target code language, a data diversification factor, and use case requirements. Moreover, the processing arrangement is configured to generate a synthetic dataset, based on the at least one seed sample and the set of system specific requirements, wherein the synthetic dataset comprises: at least one source code sample, at least one target code sample, at least one test case. Furthermore, the processing arrangement is configured to validate the at least one target code sample using the at least one test case. Furthermore, the processing arrangement is configured to segregate the synthetic dataset into a training dataset and an evaluation dataset. Furthermore, the processing arrangement is configured to determine at least one parameter to finetune the code translation model, based on the evaluation dataset. Furthermore, the processing arrangement is configured to finetune the code translation model, based on the at least one parameter. Furthermore, the processing arrangement is configured to compute an evaluation score for the finetuned code translation model, based on the evaluation dataset. Furthermore, the processing arrangement is configured to determine a training loss and an evaluation loss for the finetuned code translation model. When the evaluation score of the code translation model is less than an evaluation score of the received code translation model, the processing arrangement is configured to determine an updated at least one parameter to finetune the finetuned code translation model, based on the evaluation dataset, repeat steps from repeating steps from finetuning to determining the training loss and the evaluation loss for the finetuned code translation model, and determine a size of the synthetic dataset to be generated; or when the evaluation score of the code translation model is more than an evaluation score of the received code translation model and, when the training loss and the evaluation loss are determined to be decreasing, the processing arrangement is configured to determine an updated at least one parameter to finetune the finetuned code translation model, based on the valuation dataset, repeat steps from segregating the synthetic dataset to determining the training loss and the evaluation loss, or when the training loss and the evaluation loss are determined to be increasing, the processing arrangement is configured to approve the finetuned code translation model.

Beneficially, the embodiments of the present disclosure provide a simplified, efficient and automated system that efficiently finetune a code translation model for accurately translating a code written in one code language to another code language, which allows to efficiently switch from one operational platform to another thereby minimizing the need of reconstructing any code from scratch. Moreover, the system allows automatic finetuning a code translation language model for code-translation between a given source and target pair, thereby overcoming the requirement of exposing sensitive and critical codes to external code translation language model such as closed source large language models (LLMs) hosted through application platform interfaces (APIs) and thus mitigating security concerns. The system also automatically selects an optimal training method and hyperparameter in form of the determined at least one parameter to conduct stage wise finetuning. The system can also determine an optimal data volume for finetuning the code translation model. The system also implements a rigorous evaluation process to ensure that the finetuned code translation model significantly outperforms non-finetuned version thereof.

In another aspect, the present disclosure provides a method for finetuning a code translation model. The method comprises receiving at least one seed sample in a source code language, the code translation model, and a set of system specific requirements, from a user device, wherein the set of system specific requirements comprises: a target code language, a data diversification factor, and use case requirements. Moreover, the method comprises generating a synthetic dataset, based on the at least one seed sample and the set of system specific requirements, wherein the synthetic dataset comprises: at least one source code sample, at least one target code sample, at least one test case. Furthermore, the method comprises validating the at least one target code sample using the at least one test case. Furthermore, the method comprises segregating the synthetic dataset into a training dataset and an evaluation dataset. Furthermore, the method comprises determining at least one parameter to finetune the code translation model, based on a training dataset size, a training methodology, system infrastructure, evaluation scores of the evaluation dataset. Furthermore, the method comprises finetuning the code translation model, based on the at least one parameter. Furthermore, the method comprises computing an evaluation score for the finetuned code translation model, based on the evaluation dataset. Furthermore, the method comprises determining a training loss and an evaluation loss for the finetuned code translation model. Furthermore, the method comprises determining the finetuned code translation model to be one of: further finetuned using the synthetic dataset, finetuned using an updated synthetic dataset, or approved, based on a comparison of the evaluation score of the finetuned code translation model with an evaluation score of the received code translation model, the training loss, the evaluation loss, a historical data of previous finetuned code translation models, a size of the synthetic dataset.

The method achieves all the advantages and technical effects of the system of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIG. 1 is an illustration of a block diagram of a system for finetuning a code translation model, in accordance with an embodiment of the present disclosure;

FIG. 2 is an illustration of a flowchart depicting a synthesized dataset being generated by a processing arrangement (not shown), in accordance with an embodiment of the present disclosure;

FIG. 3 is an illustration of a flowchart depicting steps for finetuning a code translation model, in accordance with an embodiment of the present disclosure;

FIG. 4 is an illustration of a flowchart depicting steps for evaluating a finetuned code translation model, in accordance with an embodiment of the present disclosure;

FIG. 5 is an illustration of a flowchart depicting working of a controller, in accordance with an embodiment of the present disclosure; and

FIG. 6A, and 6B collectively are an illustration of a flowchart for depicting steps of a method for finetuning a code translation model, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

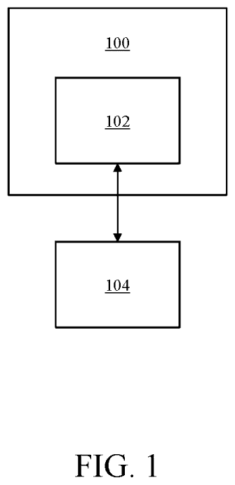

FIG. 1 is a block diagram of a system for finetuning a code translation model, in accordance with an embodiment of the present disclosure. The system 100 comprises a processing arrangement 102. Herein, the term “code translation model” refers to a Large Language Model (LLM) used for translating any code written in one coding language into another coding language. For example, translating a code written in C++into a code written in Python, using a machine learning (ML) based language model. Notably, the code translation model is used to translate or convert the code written in one coding language into another coding language providing ease of code execution in multiple platform without need to rewrite the code from scratch. Herein, the term “finetuning” refers to refining the code translation model to optimize and enhance the performance of the code translation model.

Herein, the term “processing arrangement” refers to a computational element or a combination or computational elements working together operable to execute various steps performed by the system 100. Examples of the processing arrangement 102 include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the processing arrangement 102 may refer to one or more individual processors, processing devices and various elements associated with a processing device that may be shared by other processing devices. In other words, the processing arrangement 102 may be capable of working as a standalone unit or a part of a combination of standalone units. Additionally, one or more individual processors, processing devices and elements are arranged in various architectures for responding to and processing the instructions that execute the steps of the system 100 to finetune a code translation model.

The processing arrangement 102 is configured to receive at least one seed sample in a source code language, the code translation model, and a set of system specific requirements corresponding to the code translation model, from a user device 104, wherein the set of system specific requirements comprises: a target code language, a data diversification factor, and use case requirements. Herein, the term “seed sample” refers to at least a portion of a given code. It will be appreciated that the “at least one seed sample” refers to “one seed sample” in some implementations and “a plurality of seed samples” in other implementations. Herein, the term “source code language” refers to an initial coding language of any code before translation. Notably, the at least one seed sample is in the source code language. Herein, the term “set of system specific requirements” refers to required adjustments in parameters associated with the code translation model. The set of system specific requirements are specific to the code translation model's intended purpose, limitation for the code translation model (such as computational storage requirements, operating system requirements and so on) and any such factors that affect how the code translation model is trained, and evaluated. Herein, the term “user device” is any computing device associated with a user (for example, a software developer, an operator, an artificial intelligence assistant and the like), for sharing information with the processing arrangement 102 of the system 100. The user device 104 may be, for example but not limited to, a mobile phone, a personal computer, a laptop, a desktop, a tablet, and so on. Moreover, the user device 104 being communicably coupled to the processing arrangement 102 enables the user to effectively exchange information between the user device 104 and the processing arrangement 102. Optionally, the user device 104 is communicably coupled to the processing arrangement 102 via a wired connection or wireless connection (such as a Wi-Fi® network, a Bluetooth® network, a cellular network), or any other suitable communication means. Herein, the term “target code language” refers to a preferred coding language to which any code is to be translated into by the code translation model. Herein, the term “use case requirements” refers to a specific use case that is to be taken into consideration while generating the data for training the code translation model. Optionally, the user provides the use case requirements via a description box in a user interface of the user device 104. Herin, the term “data diversification factor” as used herein refers to a parameter that defines how diversified the user wants the data for finetuning the code translation model to be. Notably, a high value for the data diversification factor enables to cover a wide range of scenarios in the data for finetuning the code translation model, whereas a low value for the data diversification factor enables to focus on specific narrow range of scenarios in the data for finetuning the code translation model. Moreover, the data diversification factor provides a control to the user over a coverage and depth of the data for finetuning the code translation model. Optionally, the user selects the data diversification factor using a user interface on the user device 104 (for example providing an input via a slider in the user interface on the user device 104).

Moreover, the processing arrangement 102 is configured to generate a synthetic dataset, based on the at least one seed sample and the set of system specific requirements, wherein the synthetic dataset comprises: at least one source code sample, at least one target code sample, at least one test case. The term “synthetic dataset” refers to the data generated for training and evaluating the code translation model. Notably, synthetic dataset is used to train and evaluate the code translation model in an iterative manner that enables to produce optimized results even with minimal data in the synthetic dataset. Optionally, the synthetic dataset is used to train the code translation model using a training method such as a supervised learning, an unsupervised learning, a semi-supervised learning, a reinforcement learning, and the like. Herein, the term “source code sample” refers to a sample code written in the source code language which is to be used an input to train the code translation model. It will be appreciated that the “at least one source code sample” is referred to “one source code sample” in some implementations and “a plurality of source code samples” in other implementations. Herein, the term “target code sample” refers to a sample code written in the target code language which is to be used an output to train the code translation model. It will be appreciated that the “at least one target code sample” is referred to “one target code sample” in some implementations and “a plurality of target code samples” in other implementations. Herein, the term “test case” refers to a refers to set of values representing an implementation scenario, that are used to execute the at least one source code sample, and the at least one target code sample. It will be appreciated that the “at least one test case” is referred to “one test case” in some implementations and “a plurality of test cases” in other implementations. Notably, executing the at least one source code sample, and the at least one target code sample using the at least one test case enables to determine an accuracy of the at least one source code sample, and the at least one target code sample and effectiveness thereof in training the code translation model. Subsequently, the at least one test case enables to determine high quality source code samples and target code samples from amongst the at least one source code sample and the at least one target code sample, respectively. Moreover, the synthetic dataset being generated, based on the at least one seed sample and the set of system specific requirements ensures that the at least one source code sample, the at least one target code sample, and the at least one test case are generated by taking into consideration the data diversification factor, and the use case requirements.

For example, the received at least one seed sample is as follows (written in Java):

```
  import java.util.*;
  import java.lang.*;
  class Solution {
  public boolean hasCloseElements(List<Double> numbers, double threshold) {
      for (int i = 0; i < numbers.size( ); i++) {
      for (int j = i + 1; j < numbers.size( ); j++) {
              double distance = Math.abs(numbers.get(i) − numbers.get(j));
                  if (distance < threshold)
                return true;
                }
      }
              return false;
              }
      }
Use case requirements: Code should have detailed docstrings
Diversity Data Factor [0-10, breadth-depth, low-high]: 3
The source code sample (using Java as the source code language) generated is:
  import java.util.*;
  import java.lang.*;
  class Solution {
    /**
      *Check if in given list of numbers, are any two numbers closer to each other
  than given threshold.
        * Additionally, ensure that the list contains at least one positive and one
  negative number.
      * >>> hasCloseElements(Arrays.asList(1.0, 2.0, 3.0), 0.5) false
      * >>> hasCloseElements(Arrays.asList(1.0, 2.8, 3.0, 4.0, 5.0, 2.0), 0.3) true
      * >>> hasCloseElements(Arrays.asList(−1.0, 2.8, 3.0, 4.0, 5.0, 2.0), 0.3) true
      * >>> hasCloseElements(Arrays.asList(−1.0, −2.8, −3.0, −4.0, −5.0, −2.0), 0.3)
  false
      */
    public boolean hasCloseElements(List<Double> numbers, double threshold) {
        if (numbers == null || numbers.size( ) < 2) {
            throw new IllegalArgumentException(“List must contain at least two
  numbers.”);
        }
        boolean hasPositive = false;
        boolean hasNegative = false;
        for (Double number : numbers) {
          if (number > 0) hasPositive = true;
          if (number < 0) hasNegative = true;
          if (hasPositive && hasNegative) break;
        }
        if (!hasPositive || !hasNegative) {
          return false;
        }
        for (int i = 0; i < numbers.size( ); i++) {
          for (int j = i + 1; j < numbers.size( ); j++) {
            double distance = Math.abs(numbers.get(i) − numbers.get(j));
            if (distance < threshold) return true;
          }
        }
        return false;
    }}
The target code sample (using Go as the target code language) generated is:
  package main
import (
  “errors”
  “math”
  “fmt”
)
type Solution struct{ }
func (s Solution) hasCloseElements(numbers [ ]float64, threshold float64) (bool, error) {
  if numbers == nil || len(numbers) < 2 {
      return false, errors.New(“List must contain at least two numbers.”)
  }
  hasPositive := false
  hasNegative := false
  for _, number := range numbers {
      if number > 0 { hasPositive = true }
      if number < 0 { hasNegative = true }
      if hasPositive && hasNegative { break }
  }
  if !hasPositive || !hasNegative {
      return false, nil
  }
  for i := 0; i < len(numbers); i++ {
      for j := i + 1; j < len(numbers); j++ {
              distance := math.Abs(numbers[i] − numbers[j])
              if distance < threshold { return true, nil }
      }
  }
  return false, nil
}
func main( ) {
  s := Solution{ }
  result, err := s.hasCloseElements([ ]float64{1.0, 2.0, 3.0}, 0.5)
  if err != nil { fmt.Println(err.Error( )) } else { fmt.Println(result) }
  }.
```

In an embodiment, the processing arrangement 102 is configured to generate the synthetic dataset based on at least one of: a depth-based data expansion, a breadth-based data expansion, based on the set of system specific requirements. In this regard, the term “depth-based data expansion” refers to a technique used to generate the synthetic data to be more varied by systematically exploring deeper layers of information in the set of system specific requirements. For example, the depth-based data expansion may comprise constraints prompt to add new constraints & requirements, deepen prompts to change time and space complexity, concretizing prompts to replace an existing requirement, and/or reasoning prompt to change logical reasoning steps. The term “breadth-based data expansion” refers to a technique used to increase a size and diversity of the synthetic data by generating variations of the existing data in the synthetic dataset across a wide range of examples. For example, the breadth-based data expansion may comprise prompts to change in core objective such as prompt to make changes in the at least one seed sample received. A technical effect of the synthetic dataset being generated based on the at least one of the aforementioned data expansion techniques is that generated synthetic dataset is effectively synthesized using a wide range of options.

Furthermore, the processing arrangement 102 is configured to validate the at least one target code sample using the at least one test case. It will be appreciated that the at least one test case is focused on the objective of the at least one source code sample rather than a syntax of the at least one source code sample. In an embodiment, the at least one test case is filtered using mutation testing. In this regard, the term “mutation testing” refers to introduction of a small, controlled modification namely, a mutant, to the at least one target source code sample or a copy of the at least one target source code sample to check if the at least one test case can detect such change. Notably, the at least one test case may be tested utilizing a docker execution technique to containerize the at least one test cases and executing efficiency in detection of the mutant. Subsequently, when the at least one test case fails to identify the mutant then they may be discarded, and new test cases are generated from the at least one target source code sample. Notably, such testing can ensure that the at least one test case is robust enough to validate both the at least one source code sample and translated at least one target code sample effectively. Notably, the processing arrangement 102 may define a list of inputs, function identifiers, syntax and so on required to execute the at least one target code sample against the at least one test case for filtering out at least one high-quality candidate amongst the at least one target code sample which aligns most with the objective of the at least one source code sample.

Furthermore, the processing arrangement 102 is configured to segregate the synthetic dataset into a training dataset and an evaluation dataset. Herein, the term “training dataset” refers to that portion of the synthetic dataset that is to be used for training the code translation model. Notably, the training dataset comprises a certain number of the at least one source code sample, the at least one target code sample, and the at least one test case to be used for training the code translation model. Herein, the term “evaluation dataset” refers to that portion of the synthetic dataset that is to be used for evaluating the effectiveness of the code translation model after being finetuned. Notably, the training dataset comprises a certain number of the at least one source code sample, the at least one target code sample, and the at least one test case to be used for evaluating the finetuned code translation model. Moreover, the evaluation dataset comprises evaluation parameters (such as execution level evaluation scores and Gen AI based scoring mechanisms) on which the finetuned code translation model is to be evaluated.

Furthermore, the processing arrangement 102 is configured to determine at least one parameter to finetune the code translation model, based on a training dataset size, a training methodology, system infrastructure, evaluation scores of the evaluation dataset. Herein, the term “at least one parameter” refers to one or more parameters that specifies what and how are the adjustments or modifications to be made to the code translation model for finetuning. Notably, the at least one parameter being determined based on the training dataset size (i.e., how much data is present in the training dataset), the training methodology (i.e., a specific method that is employed for training using the training dataset), the system infrastructure, the evaluation scores (i.e., scores that indicate the effectiveness of the evaluation dataset) of the evaluation dataset enables to use the inefficiencies in the code translation model identified using the evaluation dataset to determine the at least one parameter. Moreover, the evaluation dataset is employed in an evaluation pipeline by the processing arrangement 102 to determine the at least one parameter. In an embodiment, the at least one parameter comprises at least one of: a finetuning method, a hyperparameter. In this regard, the term “finetuning method” refers a computing technique to be employed to finetune the code translation model. Optionally, the finetuning method is one of: full SFT, LoRA finetuning method. The term “hyperparameter” refers to a configuration setting that controls and governs a learning process of the code translation model, influencing how well the code translation model learns. The hyperparameter may be used to define a learning rate, number of training iterations and the like for the code translation model. A technical effect of the at least one parameter comprising at least one of the aforementioned parameters is that the at least one parameter effectively contains information regarding the changes required to be made to effectively finetune the code translation model.

Furthermore, the processing arrangement 102 is configured to finetune the code translation model, based on the at least one parameter. Notably, what and how the changes that are determined to be made in the code translation model in form of the at least one parameter are implemented by the processing arrangement 102 in the code translation model and subsequently, the finetuned code translation model is generated by the processing arrangement 102.

Furthermore, the processing arrangement 102 is configured to compute an evaluation score for the finetuned code translation model, based on the evaluation dataset. Herein, the term “evaluation score” refers to the a numerical value that indicates an efficacy and efficiency of the finetuned code translation model. The evaluation score for the finetuned code translation model to be of a higher value indicates the finetuned code translation model to be more efficient and effective than another finetuned code translation model for which the evaluation score is less. Notably, the evaluation score is generated based on the set of system specific requirements in the evaluation dataset which define model evaluation rules to assess the efficiency of the code translation model. The term “model evaluation rules” refers to a set of rules based on which the code translation model after finetuning is to be evaluated. In this regard, the model evaluation rules provide a structured way to understand how well the code translation model is performing with respect to the use case requirements, after finetuning. Optionally, the model evaluation rules comprises different types of evaluation scores or parameters based on which the finetuned code evaluation model is to be evaluated. The evaluation score further depends on evaluating the code translation model against the received code translation model and assessing how efficient or deficient the finetuned code translation model is compared to the received code translation model. In an implementation, the evaluation score of the code translation model comprises at least one of: an execution-based pass@k metric, logical similarity metric. In this regard, the term “execution-based pass@k metric” refers to a metric used to evaluate the code translation model's ability to generate correct translated code in the target code language on the k^{th} attempt. For example, pass@1 checks whether the code produced by the code translation model successfully runs and produces the correct result when tested against the evaluation dataset on the very first try. The closer the execution-based pass@k metric is to 1 the more efficient the code translation model is. For example, a code translation model namely, DeepSeek-Coder-V2-Lite-Instruct has an execution-based pass@1 metric of value 0.6548, and after finetuning the same code translation model namely, DeepSeek-Coder-V2-Lite-Instruct, by the processing arrangement 102, the execution-based pass@1 metric is valued to be 0.7419. It means that the finetuned DeepSeek-Coder-V2-Lite-Instruct code translation model is more efficient than the received DeepSeek-Coder-V2-Lite-Instruct code translation model. Herein, the term “logical similarity metric” refers to a metric obtained when the finetuned code translation model is evaluated against the received code translation model to define the performance of the finetuned code translation model in terms of similarity to the performance of the received code translation model. A technical effect is that the evaluation score comprises well-known and reliable metrics that provide accurate evaluation score of the code translation model.

In an embodiment, the processing arrangement is further configured to create a version of the code translation model after finetuning, and wherein to generate the evaluation score for the finetuned code translation model, the processing arrangement is further configured to compare the version of the finetuned code translation model to a prior version of the code translation model. In this regard, the term “version” refers to a different variation of the code translation model that is created after the finetuning of the code translation model. Notably, the version of the finetuned code translation model to the prior version of the code translation model to generate the evaluation score for the finetuned code translation model enables to effectively take into consideration how the version of the finetuned code translation model operates differently from the prior version of the code translation model for providing enhanced results in translation of any code. A technical effect is that an accuracy of the evaluation score is enhanced due to the comparison of the version of the finetuned code translation model to the prior version of the code translation model.

Furthermore, the processing unit 102 is configured to determine a training loss and an evaluation loss for the finetuned code translation model. Herein, the term “training loss” refers to an error measured in the predicted efficacy of the training dataset. Herein, the term “evaluation loss” refers to an error measured in the predicted efficacy of the evaluation dataset. Notably, the training loss and the evaluation loss being determined for the finetuned code translation model enables to determine how effectively the code translation model has learned about the training dataset and the evaluation dataset, and how generalized are the training dataset and the evaluation dataset.

Furthermore, the processing unit 102 is configured to determine the finetuned code translation model to be one of: further finetuned using the synthetic dataset, finetuned using an updated synthetic dataset, or approved, based on a comparison of the evaluation score of the finetuned code translation model with an evaluation score of the received code translation model, the training loss, the evaluation loss, a historical data of previous finetuned code translation models, a size of the synthetic dataset. Notably, the finetuned code translation model is determined to be further finetuned using the synthetic dataset when the finetuned code translation model is deemed to be under-trained and subsequently, the further finetuning enables to remove the inefficiencies from the finetuned code translation model. Moreover, the finetuned code translation model is determined to be finetuned using the updated synthetic dataset when the synthetic dataset is deemed to be inefficient for finetuning the code translation model. Herein, the term “updated synthetic dataset” is referred to as a modified version of the synthetic dataset. Notably, the updated synthetic dataset enables to determine updated at least one parameter to finetune the finetuned code translation model using the updated synthetic dataset. Furthermore, the finetuned code translation model is determined to be approved when the finetuned code translation model is deemed to be trained up to a required standard and is suitable to be used for translating codes from the source code language to the target code language. It will be appreciated that the finetuned code translation model being determined to be one of: further finetuned using the synthetic dataset, finetuned using an updated synthetic dataset, or approved, based on the aforementioned parameters enables to use a wide range of parameters for improved decision making on the finetuned code translation model. Herein, the comparison of the evaluation score of the finetuned code translation model with the evaluation score of the received code translation model enables to determine if the finetuned code translation model is under-trained or trained up to the required standard. Herein, the historical data of the previous finetuned code translation models refers to data related to past performance and a quality of the code translation models that have been previously trained using the system. Herein, the size of the synthetic dataset refers to an amount of data that is present in the synthetic dataset. Notably, the size of the synthetic dataset enables to determine different hyper parameters like batch size, number of epochs, etc for finetuning the finetuned code translation model. Subsequently, if the size of the synthetic dataset is high, then a larger batch size is determined which enables to achieve high evaluation score the finetuned code translation model.

In an exemplary implementation, when the evaluation score of the code translation model is less than the evaluation score of the received code translation model, the processing arrangement 102 is configured to determine the updated at least one parameter to finetune the finetuned code translation model, based on the training dataset and the evaluation dataset. Furthermore, when the evaluation score of the code translation model is less than the evaluation score of the received code translation model, the processing arrangement 102 is configured to repeat steps from finetuning to determining the training loss and the evaluation loss for the finetuned code translation model. It will be appreciated that the steps from finetuning to determining the training loss and the evaluation loss for the finetuned code translation model are performed similarly to how the steps from finetuning to determining the training loss and the evaluation loss are performed for the code translation model by the processing arrangement 102. Furthermore, when the evaluation score of the code translation model is less than the evaluation score of the received code translation model, the processing arrangement 102 is configured to determine the size of the synthetic dataset to be generated. Alternatively, when the evaluation score of the code translation model is more than an evaluation score of the received code translation model, and when the training loss and the evaluation loss are determined to be decreasing, the processing arrangement 102 is configured to determine the updated at least one parameter to finetune the finetuned code translation model, based on the evaluation dataset, and repeat steps from finetuning to determining the training loss and the evaluation loss for the finetuned code translation model. Alternatively, when the evaluation score of the code translation model is more than an evaluation score of the received code translation model, and when the training loss and the evaluation loss are determined to be increasing, the processing arrangement 102 is configured to approve the finetuned code translation model.

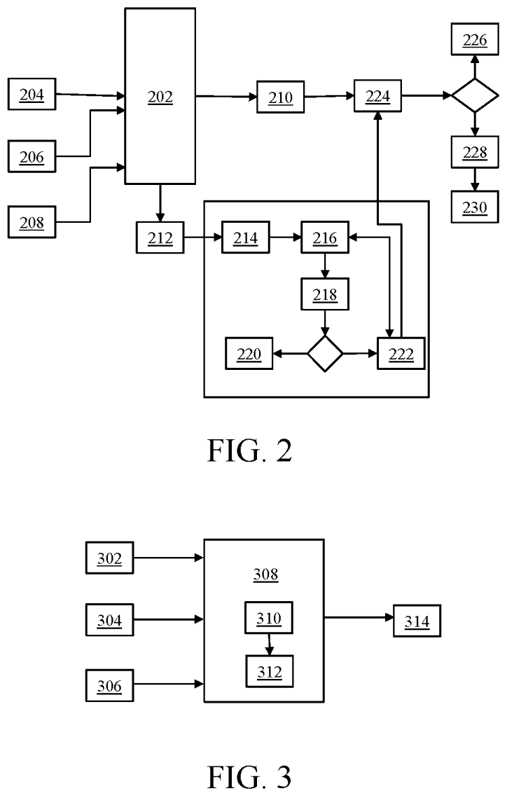

Referring to FIG. 2, illustrated is a flowchart depicting a synthesized dataset being generated by a processing arrangement (not shown), in accordance with an embodiment of the present disclosure. At step 202, at least one source code sample is generated, based on the at least one seed sample 204, use case requirements 206 and a data diversification factor 208. At step 210, at least one target code sample is generated, from the at least on source code sample. At step 212, at least one test case in a target code language is generated. Notably, executing the at least one source code sample, and the at least one target code sample using the at least one test case enables to determine an accuracy of the at least one source code sample, and the at least one target code sample and effectiveness thereof in training the code translation model. At step 214, the at least one test case is subjected to mutation testing. At step 216, at least one mutant codes are generated. At step 218, the at least one test case are tested against the at least one mutant codes using a first docker execution. Notably, such testing can ensure that the at least one test case is robust enough to validate both the at least one source code sample and translated at least one target code sample effectively, which increases a quality of the evaluation dataset for evaluating the finetuned code translation model. At step 220, if the docker executions fails, the at least one test case is corrected. At step 222, if the docker execution passes, the at least one test case is updated. At step 224, the at least one target code sample is validated using the at least one test case using a second docker execution. At step 226, the at least one target code sample is deemed as failed to be discarded. Alternatively, at step 228, the at least one target code sample is deemed as passed to be approved for further processing. At step 230, the approved at least one target code sample, the at least one source code sample, and the at least one test case are generated as the synthetic dataset.

Referring to FIG. 3, illustrated is a flowchart depicting steps for finetuning a code translation model, in accordance with an embodiment of the present disclosure. At step 302, the training dataset is received. Notably, the training dataset is segregated from a synthetic dataset. At step 304, details on use case requirements are received. At step 306, information on the code translation model which is to be finetuned is received. At step 308, at least one parameter is configured automatically, based on a training dataset size, a training methodology, system infrastructure, evaluation scores of the evaluation dataset. It will be appreciated that the at least one parameter being determined based on the training dataset size, the training methodology, the system infrastructure, the evaluation scores of the evaluation dataset enables to use the inefficiencies in the code translation model identified using the evaluation dataset to determine the at least one parameter. Notably, the at least one parameter refers to the training method and the hyperparameter required to finetune the code translation model. At step 310, the training method is selected based on a size of training dataset, and the evaluation score of the code translation base model. At step 312, the hyperparameter is selected based on a size of the code translation model, and the model evaluation rules. Herein, the at least one parameter comprising the hyperparameter ensures that the at least one parameter effectively contains information regarding the required changes to finetune the code translation model with improved efficacy. At step 314, the code translation model is finetuned.

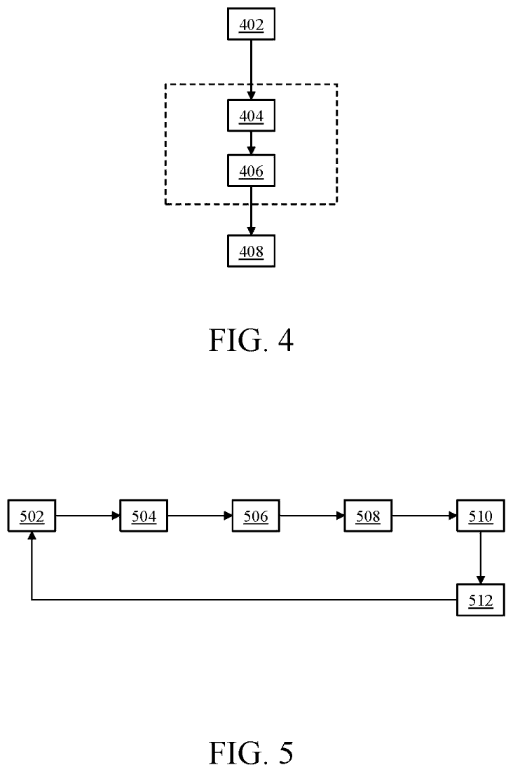

Referring to FIG. 4, illustrated is a flowchart depicting steps for evaluating a finetuned code translation model, in accordance with an embodiment of the present disclosure. At step 402, an evaluation dataset is received. At step 404, a finetuned code translation model is evaluated based on the evaluation dataset. At step 406, the finetuned code translation model is evaluated by proving evaluation dataset as input and validating an output against the finetuned code translation model. At step 408, the evaluation score for the finetuned code translation model is generated which comprises the execution-based pass@k metric and/or logical similarity metric. The evaluation score for the finetuned code translation model to be of a higher value indicates the finetuned code translation model to be more efficient and effective than another finetuned code translation model for which the evaluation score is less. Notably, the evaluation score is generated based on the set of system specific requirements in the evaluation dataset which define model evaluation rules to assess the efficiency of the code translation model. It will be appreciated that the evaluation score comprising the execution-based pass@k metric and/or logical similarity metric enables to provide accurate evaluation score of the code translation model.

Referring to FIG. 5, illustrated is a flowchart depicting working of a controller, in accordance with an embodiment of the present disclosure. In this regard, the processing arrangement 102 may also comprise the controller which is configured to perform after-evaluation adjustments to the finetuned and evaluated code translation model, as required. In this regard, at step 502, the input comprising at least one seed sample is received. At step 504, the synthetic dataset is generated based on the at least one seed sample received. Notably, the synthetic dataset is segregated into training dataset and evaluation dataset, for finetuning the code translation model and evaluating the finetuned code translation model. At step 506, the at least one parameter is configured automatically. It will be appreciated that the at least one parameter being determined based on the training dataset size, the training methodology, the system infrastructure, the evaluation scores of the evaluation dataset enables to use the inefficiencies in the code translation model identified using the evaluation dataset to determine the at least one parameter. At step 508, the code translation model is finetuned based on the configured at least one parameter. At step 510, the finetuned code translation model is evaluated using a controller 512, to determine the finetuned code translation model to be one of: further finetuned using the synthetic dataset, finetuned using an updated synthetic dataset, or approved, based on a comparison of the evaluation score of the finetuned code translation model with an evaluation score of the received code translation model, the training loss, the evaluation loss, a historical data of previous finetuned code translation models, a size of the synthetic dataset.

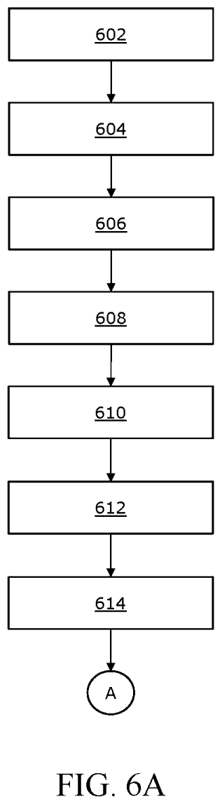

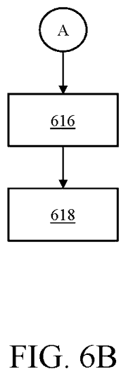

Referring to FIGS. 6A and 6B collectively, illustrated is a flowchart for depicting steps of a method for finetuning a code translation model, in accordance with an embodiment of the present disclosure. At step 602, at least one seed sample in a source code language, the code translation model, and a set of system specific requirements, are received from a user device, wherein the set of system specific requirements comprises: a target code language, a data diversification factor, and use case requirements. At step 604, a synthetic dataset is generated, based on the at least one seed sample and the set of system specific requirements, wherein the synthetic dataset comprises: at least one source code sample, at least one target code sample, at least one test case. At step 606, the at least one target code sample is validated using the at least one test case. At step 608, the synthetic dataset is segregated into a training dataset and an evaluation dataset. At step 610, at least one parameter is determined to finetune the code translation model, based on a training dataset size, a training methodology, system infrastructure, evaluation scores of the evaluation dataset. At step 612, the code translation model is finetuned, based on the at least one parameter. At step 614, an evaluation score is generated for the finetuned code translation model, based on the evaluation dataset. At step 616, a training loss and an evaluation loss are determined for the finetuned code translation model. At step 618, the finetuned code translation model is determined to be one of: further finetuned using the synthetic dataset, finetuned using an updated synthetic dataset, or approved, based on a comparison of the evaluation score of the finetuned code translation model with an evaluation score of the received code translation model, the training loss, the evaluation loss, a historical data of previous finetuned code translation models, a size of the synthetic dataset.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A system (100) for finetuning a code translation model, the system comprising a processing arrangement is configured to:
(i) receive at least one seed sample in a source code language, the code translation model, and a set of system specific requirements, from a user device, wherein the set of system specific requirements comprises: a target code language, a data diversification factor, and use case requirements;
(ii) generate a synthetic dataset, based on the at least one seed sample and the set of system specific requirements, wherein the synthetic dataset comprises: at least one source code sample, at least one target code sample, at least one test case;
(iii) validate the at least one target code sample using the at least one test case;
(iv) segregate the synthetic dataset into a training dataset and an evaluation dataset;
(v) determine at least one parameter to finetune the code translation model, based on a training dataset size, a training methodology, system infrastructure, evaluation scores of the evaluation dataset;
(vi) finetune the code translation model, based on the at least one parameter;
(vii) compute an evaluation score for the finetuned code translation model, based on the evaluation dataset;
(viii) determine a training loss and an evaluation loss for the finetuned code translation model; and
(ix) determine the finetuned code translation model to be one of: further finetuned using the synthetic dataset, finetuned using an updated synthetic dataset, or approved, based on a comparison of the evaluation score of the finetuned code translation model with an evaluation score of the received code translation model, the training loss, the evaluation loss, a historical data of previous finetuned code translation models, a size of the synthetic dataset.

2. The system as claimed in claim 1, wherein the processing arrangement is configured to generate the synthetic dataset based on at least one of: a depth-based data expansion, a breadth-based data expansion, based on the set of system specific requirements.

3. The system as claimed in claim 1, wherein the at least one parameter comprises at least one of: a finetuning method, a hyperparameter.

4. The system as claimed in claim 1, wherein the evaluation score of the code translation model comprises at least one of: an execution-based pass@k metric, logical similarity metric.

5. The system as claimed in claim 1, wherein the at least one test case is filtered using mutation testing.

6. A method for fine-tuning a code translation model, the method comprising:
(i) receiving at least one seed sample in a source code language, the code translation model, and a set of system specific requirements, from a user device, wherein the set of system specific requirements comprises: a target code language, a data diversification factor, and use case requirements;
(ii) generating a synthetic dataset, based on the at least one seed sample and the set of system specific requirements, wherein the synthetic dataset comprises: at least one source code sample, at least one target code sample, at least one test case;
(iii) validating the at least one target code sample using at least one test case;
(iv) segregating the synthetic dataset into a training dataset and an evaluation dataset;
(v) determining at least one parameter to finetune the code translation model, based on a training dataset size, a training methodology, system infrastructure, evaluation scores of the evaluation dataset;
(vi) finetuning the code translation model, based on the at least one parameter;
(vii) computing an evaluation score for the finetuned code translation model, based on the evaluation dataset;
(viii) determining a training loss and an evaluation loss for the finetuned code translation model; and
(ix) determining the finetuned code translation model to be one of: further finetuned using the synthetic dataset, finetuned using an updated synthetic dataset, or approved, based on a comparison of the evaluation score of the finetuned code translation model with an evaluation score of the received code translation model, the training loss, the evaluation loss, a historical data of previous finetuned code translation models, a size of the synthetic dataset.

7. The method as claimed in claim 6, wherein the step of generating at the synthetic data set is performed based on at least one of: a depth-based data expansion, breadth-based data expansion, based on the set of code translation system specific requirements.

8. The method as claimed in claim 6, wherein the at least one parameter comprises at least one of: a finetuning method, a hyperparameter.

9. The method as claimed in claim 6, wherein the evaluation score of the code translation model comprises at least one of: an execution-based pass@k metric, logical similarity metric.

10. The method as claimed in claim 6, wherein the at least one test case is filtered using mutation testing.
